(19) United States
(12) Patent Application Publication
(10) Pub. No.: US 2004/0054987 A1
(43) Pub. Date: Mar. 18, 2004

(54) System and method of an incremental file audit in a computer system

(76) Inventors: Nicki P. Sonpar, Redondo Beach, CA (US); Herbert Jordan Brown, Granada Hills, CA (US)

Correspondence Address: WAGNER, MURABITO & HAO LLP, Third Floor, Two North Market Street, San Jose, CA, 95113, US

(21) Appl. No.: 10/246,014

(22) Filed: Sep. 17, 2002

(51) Int. Cl. G06F 9/44

(52) U.S. Cl. 717/120; 717/125

(57) ABSTRACT

A file monitoring and auditing system for dynamically tracking and auditing files in a user level file system in a computer network system. The file monitoring and auditing system includes logic that allows a programmer to “privately” define file entries in a target computer system and to determine what file level changes have occurred on the target system relative to a known baseline file information. A file auditing logic tracks file discrepancies during a file audit capture period and reports these discrepancies in the form of file manifests to the programmer. Each file manifest comprises header information and file entries of all the files designated for auditing.

### FIELD OF THE INVENTION

The present claimed invention relates generally to the field of computer operating systems. More particularly, embodiments of the present claimed invention relate to a system for performing incremental file audits of user level files in a computer system.

### BACKGROUND ART

A computer system can be generally divided into four components: the hardware, the operating system, the application programs and the users. The hardware (central processing unit (CPU), memory and input/output (I/O) devices) provides the basic computing resources. The application programs (e.g., database systems, games, business programs database systems, etc.) define the ways in which these resources are used to solve computing problems. The operating system controls and coordinates the use of the hardware among the various application programs for the various users. In doing so, one goal of the operating system is to make the computer system convenient to use. A secondary goal is to use the hardware in an efficient manner.

The Unix operating system is currently used by many enterprise computer systems. Unix was designed to be a simple time-sharing system, with a hierarchical file system, which supported multiple processes. A process is the execution of a program and consists of a pattern of bytes that the CPU interprets as machine instructions (text), data and stack.

Unix consists of two separable parts: the “kernel” and the “system programs.” Systems programs consist of system libraries, compilers, interpreters, shells and other such programs which provide useful functions to the user. The kernel is the central controlling program that provides basic system facilities. The Unix kernel creates and manages processes, provides functions to access file-systems, and supplies communications facilities.

The Unix kernel is the only part of Unix that a user cannot replace. The kernel also provides the file system, CPU scheduling, memory management and other operating-system functions by responding to “system-calls.” Conceptually, the kernel is situated between the hardware and the users. System calls are the means for the programmer to communicate with the kernel.

System calls are made by a “trap” to a specific location in the computer hardware (sometimes called an “interrupt” location or vector). Specific parameters are passed to the kernel on the stack and the kernel returns with a code in specific registers indicating whether the action required by the system call was completed successfully or not.

FIG. 1 is a block diagram illustration of an exemplary prior art computer system 100. The computer system 100 is connected to an external storage device 180 and to an external drive device 120 through which computer programs can be loaded into computer system 100. The external storage device 180 and external drive 120 are connected to the computer system 100 through respective bus lines. The computer system 100 further includes main memory 130 and processor 110. The drive 120 can be a computer program product reader such a floppy disk drive, an optical scanner, a CD-ROM devices etc.

FIG. 1 additionally shows memory 130 including a kernel level memory 140. Memory 130 can be virtual memory which is mapped onto physical memory including RAM or a hard drive, for example. During process execution, a programmer programs data structures in the memory at the kernel level memory 140. User applications 160A and 160B are coupled to the computer system 100 to utilize the kernel memory 140 and other system resources in the computer system 100. In the computer system 100 shown in FIG. 1, when changes occur in the underlying operating system of the computer system, each of the computer systems coupled to the operating system have to be manually be updated with any such changes. Such an update strategy is error prone and inefficient.

Many of today's enterprise computing environments rely on horizontally scaled server farms to provide software services to users. It is common to have tens or even hundreds or replicated servers each running a replicated software stack, that combine to provide a set of services such as web services, internet caching, or streaming video. The task of administering a consistent software configuration across vast arrays of systems has been complex, labor-intensive and prone to error.

The prior art computing environment as illustrated in FIG. 2, for example, does not offer users the ability to monitor and track file level changes to user specific systems in a computer network. The prior art environment depicted in FIG. 2 does not provide a user the ability to dynamically audit individual files on the user's system relative to the software stack that is installed in the user's system on the network to which the user is connected. Thus in a system such as the one depicted in FIG. 2, file corruption on a user's system may go unnoticed by the system administrator for a long period and could eventually affect the underlying operating system. A change to any files could also lead to displacements for other programs that use the operating system. This will require the underlying operating system to be reinstalled. This can be costly and time consuming.

### SUMMARY OF INVENTION

Accordingly, to take advantage of the robustness of the Unix operating system, for instance, and the diversity of computer network systems, a system is needed that has capabilities to allow a computer system user to track file changes in user specific systems. Further, a need exists for solutions to allow users to generate snapshots of files on the system and to dynamically monitor changes to these files at different monitoring periods. A need further exists for an improved and less costly program independent operating system, which improves efficiency and provide a means to incrementally audit computer system user level files. A need further exist to provide programmers the ability to privately track existing operating system level wide files in a system specific environment, transparently to other systems that use the operating system.

What is described herein is a computer system having an operating system that provides a technique for providing incremental user specific file audits without having to recompile kernel modules in the underlying operating system in other systems using the operating system. Embodiments of the present invention allow programmers to dynamically monitor system level files to track intermittent changes to the files at various monitoring and capturing periods. Embodiments of the present invention allow a programmer to take a snapshot of a specific system at a particular time and dynamically perform queries to determine changes that might have occurred to the files from a previous capture period. In one embodiment of the present invention, the computer system includes an operating system that addresses a fixed set of software (integrated software stack) to many replicated systems connected to the operating system. The system provides techniques for system administrators to efficiently deploy, update, and manage software across a large number of systems. This enables the system administrator to better manage consistent software configuration and improve the ability to exactly know what is running on a system connected to a computer network at any particular time.

The system level file tracking and auditing logic further provides the programmer with a number of ways to monitor file localizations and configurations in a network with diverse file systems more easily and efficiently.

Embodiments of the present invention further include file baseline monitoring logic for storing a baseline image of a software stack on any server connected to a computer network. The base line image includes information in the software stack that enables the present invention to detect file discrepancies during a file audit capture period.

Embodiments of the present invention also include file comparison logic that compares file changes from the file baseline image when a file was first created or captured during a file audit period and a subsequent file audit capture period. The compare logic enables the present invention to audit file version information, etc., from a computer server's software stack. The compare logic further enables a user to determine changes that have occurred on an installed system between two reference time periods.

Embodiments of the present invention further include file create logic that provides a mechanism for capturing a snapshot image of files on a system being monitored at any particular file audit capture period. Specific files on a computer system being monitored or any entire file-systems may be monitored and audited during a file audit capture period.

Embodiments of the present invention further include file manifest generation logic. The file manifest generation logic allows a user to dynamically specify which files the user wishes to catalog for monitoring and auditing. The specification can be a list of files that the user wishes to generate or a rules-file that contains directives of which sub-tree of the user's file system in the software stack to be tracked. A respective information table may be generated for each catalog with entries and header information of the files being monitored. The information table is updated each time a file audit is performed. In the present invention, the file table includes an overhead entry that keeps track of the version information of files in the table.

Embodiments of the present invention further include file selection logic that provides a mechanism for the user to selectively define portions of the user' file system that is designated for tracking and auditing. The file selection logic further allows the user to define which attributes of the files being monitored may be tracked or ignored.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a prior art computer system;

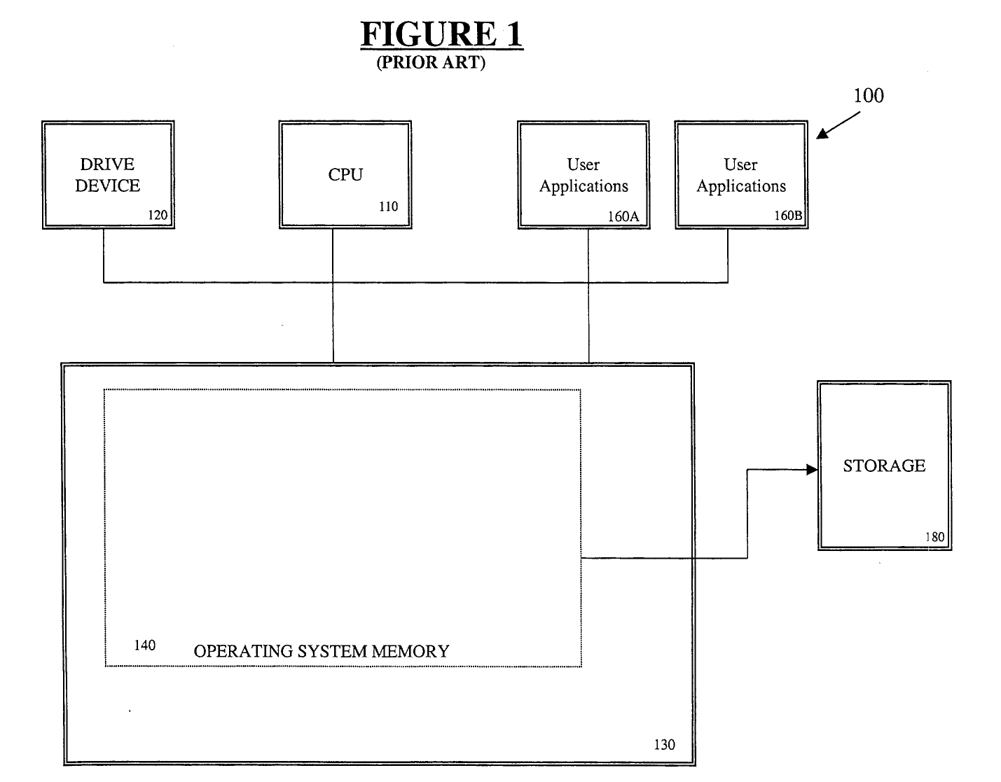

FIG. 2 is a block diagram of a prior art computer system file configuration environment;

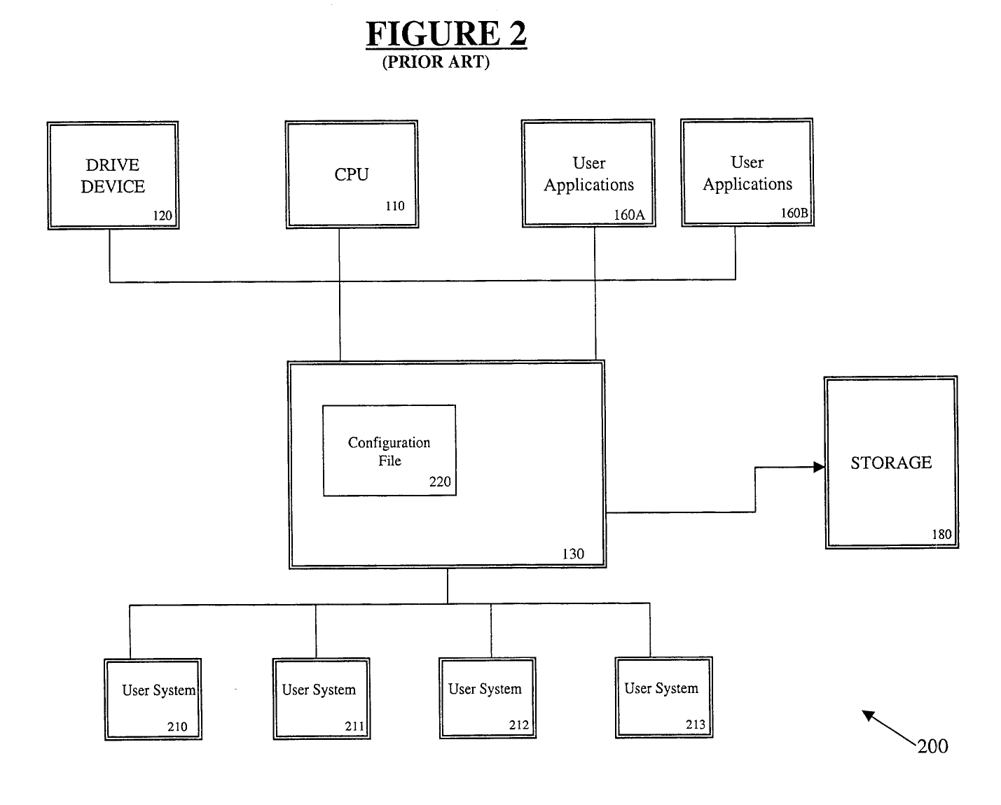

FIG. 3 is an exemplary block diagram of a computer system in accordance with the present invention;

FIG. 4 is an exemplary block diagram illustration of a file tracking and auditing environment of one embodiment of the present invention;

FIG. 5 is an exemplary embodiment of the logical functional blocks of a file tracking and auditing scheme of one embodiment of the present invention;

FIG. 6 is a block diagram of one embodiment of the file tracking and auditing system of the present invention;

FIG. 7 is a block diagram of an exemplary representation of file manifest of one embodiment of a file audit logic of the present invention; and

FIG. 8 is a flow diagram of one embodiment of file tracking and auditing of an embodiment of the file tracking and auditing system of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

The embodiments of the invention are directed to a system, an architecture, subsystem and method to track and audit user defined files in a computer file system that may be applicable to operating system kernels. In accordance with an aspect of the invention, a file tracking system provides a user the ability to dynamically define user level files for particular applications to the underlying operating system for tracking and auditing without affecting other programs using the operating system.

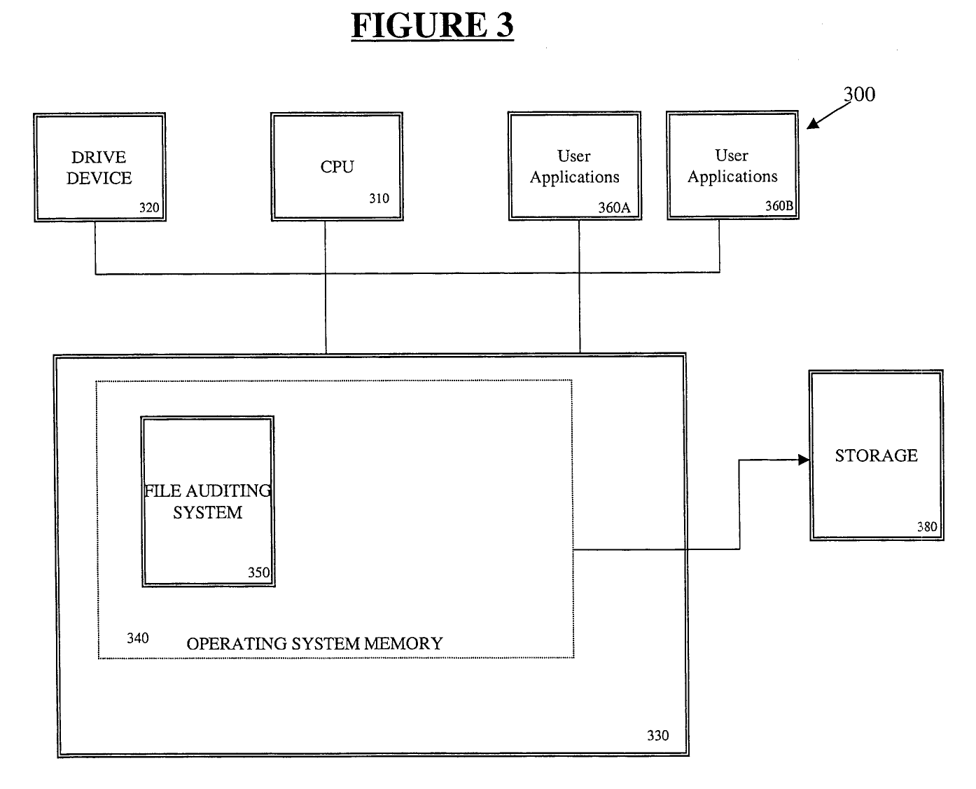

FIG. 3 is a block diagram illustration of one embodiment of a computer system 300 of the present invention. The computer system 300 according Lo the present invention is connected to an external storage device 380 and to an external drive device 320 through which computer programs according to the present invention can be loaded into computer system 300. External storage device 380 and external drive 320 are connected to the computer system 300 through respective bus lines. Computer system 300 further includes main memory 330 and processor 310. Drive 320 can be a computer program product reader such a floppy disk drive, an optical scanner, a CD-ROM device, etc.

FIG. 3 additionally shows memory 330 including a kernel level memory storing an operating system 340. Memory 330 can be virtual memory which is mapped onto physical memory including RAM or a hard drive, for example, without limitation. During process execution, a programmer programs data structures in the memory at the kernel level memory. According to an embodiment of the present invention, the operating system includes a file tracking and auditing system 350. The file tracking and auditing software system 350 enables a programmer to dynamically designate specific files with a file system for tracking and auditing to determine discrepancies between the files and a baseline image of the files during a prior audit capturing period.

The file tracking and auditing system 350 enables a user to determine what file level changes have occurred on a target system relative to a known baseline file previously created by the user. In one embodiment of the present invention, the file tracking and auditing system 350 informs a user of changes on an installed system between two points in time. The file tracking and auditing system 350 may also be used for system-to-system comparisons which can be useful in environments where a group of systems should be running similar software stack. The file tracking and auditing creates a baseline catalog of file attributes from a fully installed and configured computer system. The baseline can then be compared to a snapshot at a later time generating a list of file level changes that have occurred since the installation of the target computer system.

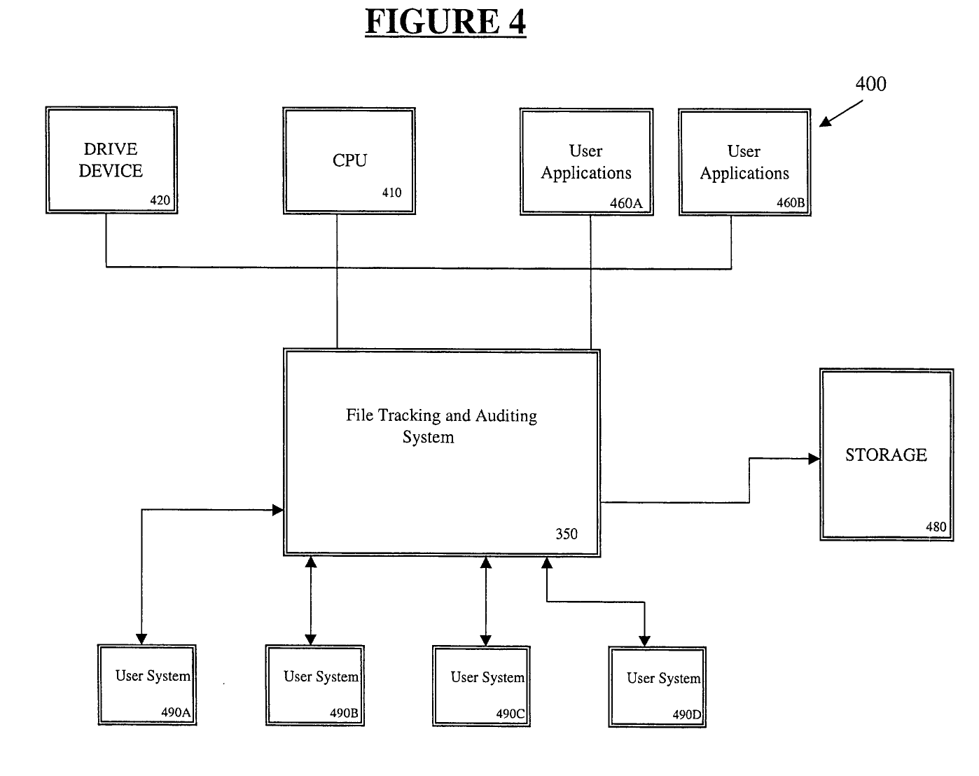

FIG. 4 is a block diagram illustration of one embodiment of a computer network environment 400 employing the teachings of the file tracking and audit system 350 of the present invention. The network environment illustrated in FIG. 4 comprises CPU 410, drive device 420, user applications 460A-460B, the file tracking and auditing system 350, storage device 480 and user systems 490A-490D. In the environment shown in FIG. 4, each of the user systems 490A-490D communicates directly with the file tracking and auditing system 350 to allow each user to independently track the status of files in each system. Having each system communicate with the file tracking and auditing system 350, enables a system administrator to apply specific and individual software updates to each of systems 490A-490D without having to manually apply the same sets of changes across the network.

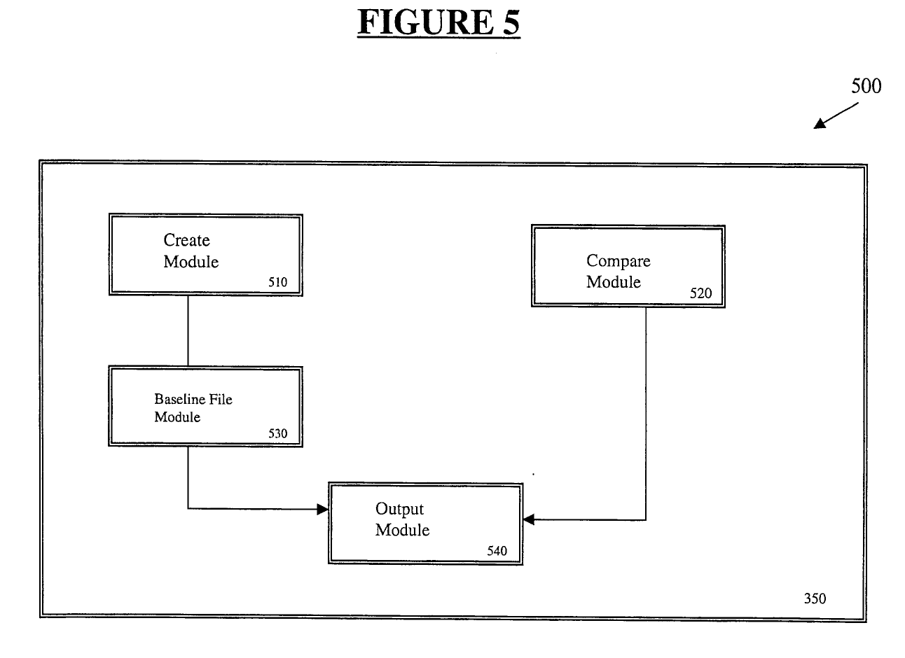

FIG. 5 is a block diagram of one embodiment of the logical blocks of the file tracking and auditing system 350 of the present invention. As illustrated in FIG. 5, the system 350 functional blocks comprises file create logic module 510, file compare logic module 520, baseline file logic module 530 and output module 540.

Taking snapshots of files being monitored by the user is done through the file create logic module 510. The file create logic module 510 generates a catalog of file attributes referred to as a “manifest”. Comparison of two manifests is discrepancies between a control and a test manifest via the output module 540. The control manifest comprises baseline characteristics of the files being monitored in the baseline file module 530.

In one embodiment of the present invention, the file tracking and auditing system 350 generates manifests of a given user system over a period of time. The user can generate a report by comparing old and new manifests when the user's file system needs to be validated. In another embodiment, the user may generate manifest of several similar systems over a computer network and perform system-to-system comparisons to determine discrepancies between similar files on each system.

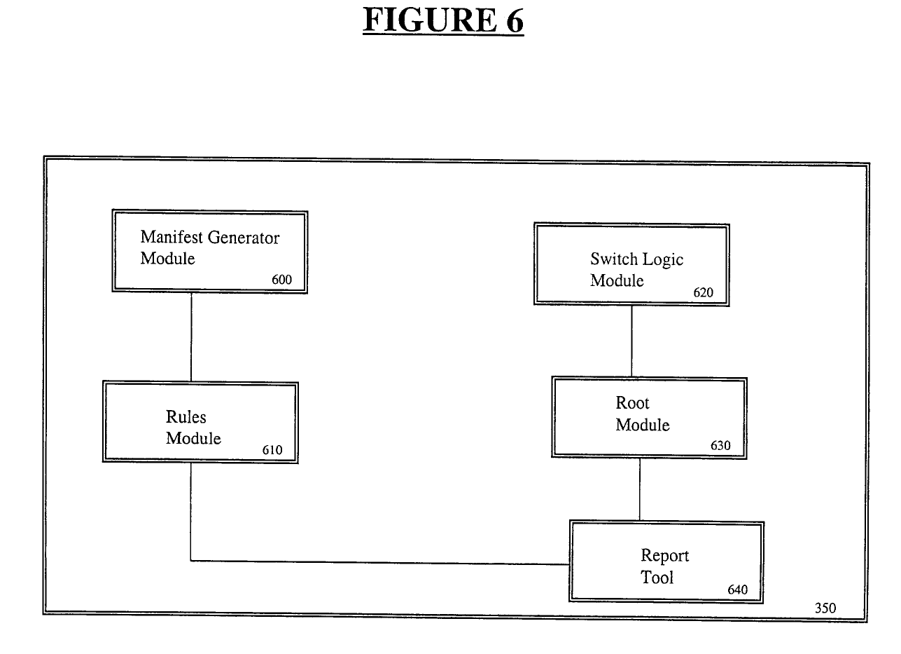

Referring now to FIG. 6, a block diagram illustrating an embodiment of the internal architecture of the file tracking and auditing system 350 is shown. As shown in FIG. 6, the file tracking and auditing system 350 comprises file manifest generation module 610, file audit switching logic module 620, root file logic 630 and report generation logic module 640.

The file manifest generation module 610 generates a catalog of file attributes corresponding to the files identified by the user for tracking and auditing. The manifest generation logic 610 also allows the user to specify which files are to be cataloged. This specification can be in the form of a list of files the user wishes to generate. The file catalogs may also be a directory containing a list of directives about which sub-tree in the user's file system to track.

The file manifest catalog may also be generated based on the contents of the rules logic module 620. The rules logic module 620 includes directives that the tracking and auditing system 350 may use to track and audit files in the user's file-system. In one embodiment of the present invention, the rules logic 620 reads directives from standard input files or programs in the computer system.

In one embodiment, all directives are grouped into logical blocks. If the first statement in a file is either “CHECK” or “IGNORE” statements, the statements are considered global to all subsequent blocks for tracking. The input files to the Create logic 410 and the Compare logic 420 are text files comprising of links specifying which files and attributes are to be included in a particular audit.

The same input file may be used across both processes of the track and audit functionality. In one embodiment of the present invention, the rules logic 620 generates three types of directives: 1) a sub-tree directive with optimal pattern match modifiers, 2) a CHECK directive and 3) an IGNORE directive. All CHECK and IGNORE directives after a sub-tree directive pertains only to that particular sub-tree. In the case where a sub-tree should simply inherit the global CHECK and IGNORE statements, a “CHECK” with no parameters can also be used. For a given block, “CHECK” and “IGNORE” statements are processed in the order in which they were read from the file. An exemplary directive statement looks as follows:

<Global CHECK/IGNORE Directives>
<subtree 1> [pattern 1...]
<subtree 2> [pattern 2 ...]
<subtree 3> [pattern 3 ... ]
<IGNORE/CHECK Directives for subtree 3, subtree 3, subtree 4>

Note that all directives are read in order with later directives overriding earlier directives. There is one subtree directive per line and it begins with an absolute pathname followed by zero or more pattern match statements. For a given subtree directive, all patterns match statements are logically ANDed with the subtree. Patterns have the following syntax:

a. Wildcards are allowed for both the subtree and pattern match statements.

b. “!” is used as a logical NOT

c. a pattern that does not end in a “/” is assumed to be a non-directory.

d. A pattern that does end in a “/” signifies a subtree. The subtree definition itself does not require an ending “/”.

For example:

/home/nickiso/src!*.o !core !SCCS/

This line will include the entire subtree of “/home/nickiso/src”, except for object files, core files and all the SCCS subtrees. Directories named “core” or “dirname.o” will be selected since there is no trailing slash after “core” or “*.o”.

An exemplary quoting syntax for representing non-standard filenames is as follows:

\(space) will be interpreted as (space)
\ \ will be interpreted as \
\(tab) will be interpreted as (tab)
\t will be interpreted as (tab)
\n will be interpreted as newline
\? Will be interpreted as ?
\[ will be interpreted as [
\* will be interpreted as *

Lines beginning with “#” and lines consisting entirely of white-space are ignored. Furthermore, when generating a manifest for files that contain a tab, space or newline, those files will have those characters represented in their local form, e.g., \040 for the space character.

It is possible to group multiple subtree directives together. In this case, all subtree directives are logically Or'ed together. For example:

/home/nickiso/src !*.o ! core
/home/nickiso/Mail
/home/nickiso/docs *.sdw

In one embodiment of the present invention, the following interpretation: under ‘/home/nickiso/src’, excludes all non-directories that end in “.o” or directories that have the name ‘core’. Typically, this would exclude all object and core files.

Include ‘/home/nickiso/Mail’ subtree

Under ‘/home/nickiso/docs’, include all non-directories ending with ‘*.sdw”

The CHECK and IGNORE statements allow users to define which attributes they want tracked or ignored by the system 350. Each attribute has an associated keyword. In the case of a file being tracked that belongs to more than one subtree, an exemplary resolution is achieved by:

1. tracking which CHECK and IGNORE flags are set in the global block, if any. In one embodiment of the present invention, all CHECKS and IGNORE statements are processed in order.

2. Finding the last subtree directive that matches the file

3. Processing the CHECK and IGNORE statements that belong to the last matching subtree, in order in which they were read.

In one embodiment of the present invention, an exemplarly directive file will have the following entries:

# Global rules, track everything except the mtime on
#directories.
CHECK all
IGNORE dirmtime
#The files in/data 1 -> /dataN are expected to change, so
#don't bother tracking the attributes. Furthermore, the #'IGNORE
contents' will save time and resources.
/data*
IGNORE contents mtime size
/home/nickiso f* bat/
IGNORE acl
#For /usr, simply apply the global rules
. ...
.....
/usr/tmp
/home/nickiso *.o
INGORE all

The above exemplary directive file would be cataloged as follows:

a. for files under the subtree ‘/data*’, all attributes except for the dirmtime, mtime, size and content attributes.

b. All files under the subtree ‘/usr’ will be cataloged using the global rules except for the subtree ‘/usr/tmp’/ which is ignored.

Still referring to FIG. 6, the root logic module 630 specifies a root directory for the file manifest. All paths specified by the rules logic 620 are interpreted relative to the root directory. In one embodiment of the present invention, all paths reported in the manifest are relative to the root directory.

The report logic generation module 640 takes two manifests as inputs and generates reports as to the discrepancies in particular files between the manifests as well as additions and deletions between the manifests. Users can optionally supply the rulesfile to override default behavior and generate custom reports. In one embodiment of the present invention, the report logic generation module 640 generates two types of outputs: 1) verbose and 2) programmatic. The verbose output is a human readable file and the programmatic output is a machine radable file more easily parsable by other programs on the computer system.

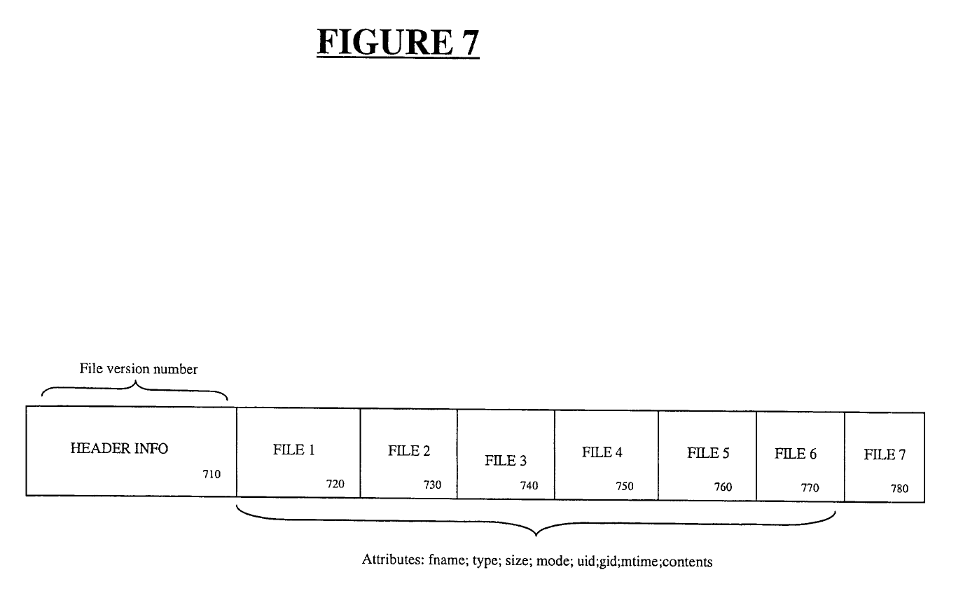

FIG. 7 is an exemplary block diagram illustration of one embodiment of the file manifest catalog of the present invention. The exemplary file catalog 700 comprises header information 710 and file instances 720-780 each of which comprises information unique to the particular file being monitored. In the example illustrated in FIG. 7, the file instances 720-780 represent file entries in the user level file system on a particular user machine or server.

In one embodiment of the present invention, each of the entries 720-780 can have corresponding file attributes comprising the filename, a file type, a file size, file mode, a user identification ( e.g., uid), a file group identification (e.g., gid), a file creation time and the file contents. The header information 710 comprises a file version number, the date and time of creation. An exemplary entry of the manifest catalog include the following:

! Version #
!Date: day, month, year; time
#format
#fname D size mode acl uid gid mtime [xattr xcontents]
#fname B size mode acl uid gid mtime devnode [xattr xcontents]
#fname C size mode acl uid gid mtime devnode [xattr xcontents]

Every manifest has a header 710. All lines in the header information beginning with “!” supply metadata about the manifest. “Version” describes the version of the manifest specification. “Date” is the date the manifest was generated. Lines beginning with “#” and lines consisting entirely of whitespace are ignored.

In one embodiment of the present invention, the attribute keywords are as follows:

Fname: the name of the file. To prevent parsing issues with nonstandard file names, such as filenames with a newline or a tab, the nonstandard character will be encoded using a quoting syntax.

Type: file types are represented as follows:

D: directory;

P: pipes;

S: sockets;

F: regular files;

L: symbolic links;

B: block devices;

C: character devices;

size: is the file size in bytes;

mode: is the conventional Unix file permissions in octal form. This includes setuid, setgid and sticky bits;

acl: for files with ACL attributes, the output from acltotext( ). For files without ACL attributes, “-”;

uid: is the user id of the owner of the entry;

gid: group id of the owner of the entry;

devnode: denotes major and minor values of the device node in “dev_t” notation for character and block device files only;

mtime: is the non-directory and non-symbolic link modification time in seconds; and

[xattr xcontents]: zero or more attribute names and MD5 checksum pairs for the extended attributes, in alphabetical order. For files with extended attributes only.

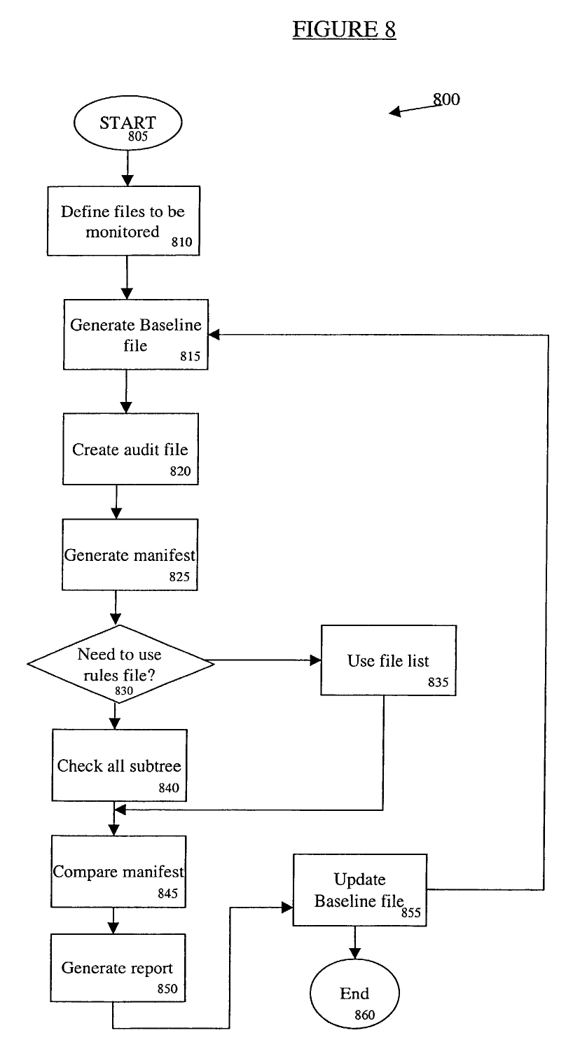

FIG. 8 is flow diagram of an exemplary computer implementation 800 of one embodiment of the file tracking and auditing system 350 of the present invention. As illustrated in FIG. 8, a file audit is initiated 805 by the user defining 810 files that the user wishes the file tracking and auditing system 350 to track.

The file tracking and auditing system 350 then generates at step 815 a baseline file characteristics of the files defined or specified by the user for tracking. When the tracking system 350 initiates a file audit of the user defined files, the system 350 initiates the create file logic 510 to create (at step 820 ) an audit file. The create logic 501 generates at step 825 a manifest of the files being audited by comparing the current status of the files with the baseline characteristics that was generated in a prior audit.

At step 830, the tracking system 350 determines whether the user has defined a rules file 610 directive to handle the file audits. If a rules file 610 has been specified by the user, the tracking system uses the rules file 610 to check the file system subtree at step 840. On the other hand, if a rules file 610 has not been defined, the tracking system 350 uses a file list to audit the files specified for auditing at step 835.

At step 845, the tracking system 350 compares the current audit results with the baseline file to extract any discrepancies that might exist between files. If there are discrepancies between the current status of the files being audited and their baseline characteristics, the tracking system generates a report of the discrepancies at step 850. At step 855, the file baseline is updated with the new information from the audit and the audit terminates at step 860.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

1. A computer system, comprising:
a processor;
a memory storage unit;
an operating system;
an applications file system; and
a file tracking and auditing system for dynamically tracking and auditing file level changes in said applications file system.

2. The computer system of claim 1, wherein said file tracking and auditing system comprises file tracking logic for enabling a user to dynamically define files in said applications file system for monitor.

3. The computer system of claim 2, wherein said file tracking and auditing system further comprises file create logic for generating a plurality of catalogs of file attributes of said files being monitored in said applications file system during a particular file auditing time.

4. The computer system of claim 3, wherein said file tracking and auditing system further comprises file compare logic for comparing the contents of said plurality of catalogs to determine whether a catalog captured at a first audit capture period has changed from a subsequent audit capture period.

5. The computer system of claim 4, wherein during said first audit capture period a baseline file module of file characteristics of said files are captured to be compared with a snapshot of said files at a later audit capture period.

6. The computer system of claim 5, wherein said file tracking and audit system further comprises file update module for updating the contents of said baseline file module for comparing said applications file system at said later capture period.

7. The computer system of claim 6, wherein said file tracking and auditing system further comprises a file manifest generating logic for allowing a user to dynamically define which files to be cataloged for auditing in said applications file system.

8. The computer system of claim 7, wherein said file definition comprises a list of files.

9. The computer system of claim 8, wherein said dynamic file definition comprises a rules-file comprising directives of which sub-trees in said applications file system to track.

10. The computer system of claim 9, wherein said file manifest file module comprises header information and a plurality of file entries for each file cataloged.

11. The computer system of claim 10, wherein said file tracking and audit system further comprises a selective automatic switch logic for selectively initiating a file audit in said applications file system.

12. The computer system of claim 11, wherein said file tracking and auditing file attributes to track and ignore during said file audit capture period.

13. A computer operating system, comprising:
a kernel comprising a plurality of user level file systems;
file tracking and auditing logic for dynamically tracking files in said user level file system types; and file monitoring profile logic for allowing a programmer to dynamically modify profile information of said files during a file audit capture period.

14. The computer operating system of claim 13, wherein said file tracking and auditing logic comprises file tracking logic for enabling a user to dynamically define files types in said plurality of user level file system types that the user wishes to monitor.

15. The computer operating system of claim 14, wherein said file tracking and auditing logic further comprises file create logic for generating a plurality of catalogs of file attributes of said files being monitored in said plurality of user level file systems during a particular file auditing period.

16. The computer operating system of claim 15, wherein said file tracking and auditing logic further comprises file compare logic for comparing the contents a said plurality of catalogs to determine whether a catalog captured at a first audit capture period has changed from a subsequent audit capture period.

17. The computer operating system of claim 16, wherein during said first audit capture period a baseline file module of file characteristics of said files are captured to be compared with a snapshot of said files at a later audit capture period.

18. The computer operating system of claim 17, wherein said file tracking and audit logic further comprises a file update module for updating the contents of said baseline file module for comparing said plurality of user level file system at said later capture period.

19. The computer operating system of claim 18, wherein said file tracking and auditing logic further comprises file manifest generating logic for allowing a user to dynamically define which files to be cataloged for auditing in said user level file systems.

20. The computer operating system of claim 19, wherein said file definition comprises a list of files.

21. The computer operating system of claim 20, wherein said file definition comprises a rules-file comprising directives of which sub-trees in said user level file system to track.

22. The computer operating system of claim 21, wherein said file manifest file module comprises header information and a plurality of file entries for each file cataloged.

23. The computer operating system of claim 22, wherein said file tracking and initiating a file audit in said user level file system.

24. The computer operating system of claim 23, wherein said file tracking and auditing logic further comprises a file attribute extraction logic for determining which file attributes to track and ignore during said file audit capture period.

25. The computer operating system of claim 24, wherein a respective file catalog information table is provided for each file entry that is defined for auditing during said audit capture period.

26. The computer operating system of claim 25, wherein said file entries comprise corresponding header information in said catalog information table.

27. A computer implemented file auditing system comprising:
a file system structure comprising a plurality of file entries wherein each entry comprises a plurality of fields;
file tracking module for tracking files defined to be audited; and
file compare logic for comparing and reporting file characteristics discrepancies during a first and a second file auditing capture periods.

28. A system as described in claim 27, wherein said file tracking module comprises file tracking logic for enabling a user to dynamically define file types in said plurality of user level file system types that the user wishes to monitor.

29. A system as described in claim 28 wherein said file tracking module further comprises file create logic for generating plurality of catalogs of file attributes of said files being monitored in said plurality user level file systems during a particular file auditing period.

30. A system as described in claim 29 wherein said file tracking module further comprises file compare logic for comparing the contents of said plurality of catalogs to determine whether a catalog captured at a first audit capture period has changed from a subsequent audit capture period.

31. A system as described in claim 30 wherein during said first audit capture period a baseline file module of file characteristics of said files are captured to be compared with a snapshot of said files at a later file audit capture period.

32. A computer system, comprising:
a processor;
a memory storage unit;
a computer software applications program comprising a plurality of static data files each comprising entries, each said entries comprising fields; and
file tracking and auditing software system having a file discrepancy detection logic for dynamically defining files in said computer software application programs for monitoring and auditing during a file capture and audit period in said computer system.

33. The computer system of claim 32, wherein during said file capture and audit period discrepancies between status information of said files during a first capture period and a second capture period are captured for used as a baseline

34. The computer system of claim 33, wherein said file tracking and auditing software system comprises file compare logic for comparing the contents of said plurality of catalogs to determine whether a catalog captured at a first audit capture period has changed from a subsequent audit capture period.

35. The computer system of claim 34, wherein during said first audit capture period a baseline file module of file characteristics of said files are captured to be compared with a snapshot of said files at a later audit capture period.

36. A method of tracking and auditing file consistency is a computer system which includes a plurality of storage devices, a plurality of application programs and main memory, said method comprising:
providing file tracking logic for tracking files dynamically defined based on certain characteristics for monitoring;
providing file comparison logic for comparing various states of the files defined for monitoring during a first audit and a second audit file capture period; and
providing file auditing logic for auditing said files after said first and said second capture period to determine discrepancies between said files.

37. The method of claim 36, further comprising generating a plurality of catalogs of file attributes of said files being monitored in said plurality of user level file systems during a particular file auditing period.

38. The method of claim 37, wherein during said first audit capture period a baseline file module of file characteristics of said files are captured to be compared with a snapshot of said files at a later audit capture period.
